(19) United States
(12) Patent Application Publication
(10) Pub. No.: US 2001/0026628 A1
(43) Pub. Date: Oct. 4, 2001

(54) Passive radiator having mass elements

(75) Inventor: Guido Odilon Maurits D'Hoogh, Dendermonde (BE)

Correspondence Address: U.S. Philips Corporation, 580 White Plains Road, Tarrytown, NY, 10591, US

(73) Assignee: U. S. PHILIPS CORPORATION

(21) Appl. No.: 09/817,088

(22) Filed: Mar. 26, 2001

(30) Foreign Application Priority Data
Mar. 28, 2000 (EP) 00201112.0

(51) Int. Cl. H04R 1/02

(52) U.S. Cl. 381/345

(57) ABSTRACT

A passive radiator comprises a chassis (11) and a radiator body which is connected to the chassis and which is movable with respect to the chassis along a translation axis (T*). The radiator is capable of displacing comparatively large air volumes. The radiator body comprises a central mass element (13a) and at least one mass element (13b) which is arranged concentrically with respect to the central mass element. The radiator further comprises connection units for movably interconnecting each pair of adjacent mass elements and for movably connecting one of the mass elements to an element (11a) of the chassis. Each of said connection units comprises two resilient annular connecting rings (5a1, 5a2; 5b1, 5b2), which have two adjacent elements which are parts of said elements secured to them. The connecting rings of at least one of the connection units bound a closed chamber (17a) containing a gaseous medium in order to counteract undesired noises. The central mass element with its adjacent connection unit as well as each concentrically arranged mass element with its adjacent connecting limb forms a mass spring system, all the mass spring systems thus defined having at least substantially the same resonant frequency.

The invention relates to a passive radiator having a chassis and having a radiator body flexibly connected to the chassis and movable with respect to the chassis along a translation axis.

WO-A 97/46047 (PHN 15.840) discloses a passive radiator which comprises a chassis, a mass element, and a sub-chassis extending between the mass element and the chassis, while the mass element is movably fastened to the sub-chassis by means of a first resilient suspension ring and the sub-chassis is movably fastened to the chassis by means of a second resilient suspension ring. The maximum axial excursion of the mass element is defined by the sum of the maximum axial excursions of each of said suspension rings. It has been found that in the case of uses requiring a comparatively high axial compliance in combination with a comparatively large axial excursion of the mass element the suspension formed by the suspension rings may exhibit such distortions that undesired noises are produced in operation.

It is an object of the invention to improve the passive radiator of the type defined in the opening paragraph so as to counteract the generation of undesired noises.

This object is achieved with the passive radiator in accordance with the invention which comprises a chassis and a radiator body which is connected to said chassis and which is movable with respect to said chassis along a translation axis, the radiator body comprising a central mass element and at least one mass element which is arranged concentrically with respect to the central mass element, connection units being provided for movably interconnecting every two adjacent mass elements and for movably securing one of the mass elements to the element of the chassis, each of said connection units comprising two resilient annular connecting limbs, to which two connecting limbs two adjacent elements which form part of the said elements are secured, the connecting limbs of at least one of the connection units bounding a closed chamber which extends between the elements secured to said units and which is filled with a gaseous medium, the central mass element with its adjacent connection unit, as well as each concentrically arranged mass element with its adjacent connecting limb, forming a mass spring system, all the mass spring systems thus defined having at least substantially the same resonant frequency.

The use of two or more mass elements which are interconnected by resilient connecting limbs, also referred to as connecting rings, leads to a construction with a multiple suspension in which each mass element present contributes to the total air displacement during use. The connecting limbs are ring-shaped in view of their use. A mass element performs individual movements with respect to an adjacent mass element along the translation axis of the radiator body in operation, which results in displacements with respect to the chassis which are cumulations of individual movements. Comparatively large displacements of mass elements can be realized in this manner, so that considerable volume displacements can be achieved with a comparatively small radiator body. To counteract parasitic resonances and, as a consequence, the generation of undesired noises during use, the mass spring systems present in the passive radiator according to the invention as defined above have the same or practically the same resonance frequency. As a result of the use of one or more closed, i.e. impervious, chambers as defined in claim 1, translational movements of the radiator body produce pressure variations in the gaseous medium present between the connecting limbs of one or more connecting units. In the case of deflecting translational movements of the radiator body these pressure variations are pressure rises, which have a favorable effect on the behavior of the suspension, particularly on the connecting limbs of the respective connecting unit or units. As a matter fact, said pressure rises result in pressure being exerted on the respective connecting limbs, which pressure issues from the closed chamber or chambers and prevents the connecting limbs from behaving in an unstable manner, such as flapping, fluttering or buckling and thus producing undesired noises. This measure furthermore has the advantage that thin connecting limbs can be used, which enables a high axial compliance, i.e. a low stiffness, of the suspension formed by the connecting limbs to be achieved in the directions of translation of the radiator body. Decisive factors for the overall axial compliance of the whole arrangement are, particularly, the compliance of the medium in the closed chamber or chambers and the resistance to deformation of the suspension. As gaseous medium a gas, air or another gas mixture may be used.

An embodiment of the passive radiator in accordance with the invention is characterized in that the connection units allow mainly movements of the mass elements along the translation axis of the radiator body and counteract other movements. In this embodiment it is prevented that the mass elements perform undesired tilting movements with respect to one another during operation, which tilting movements could lead to distortions in the sound reproduction. The annular connecting limbs used may be made from resilient materials which are known per se such as polyurethane or rubber and preferably have a folded or corrugated structure.

An embodiment of the radiator in accordance with the invention is characterized in that a sealed chamber extends at least between the connecting limbs of the connection unit which adjoins the central mass element.

The embodiment of the radiator in accordance with described above is preferably characterized in that the central mass element has a projection which extends to a location between the connecting limbs of the connection unit which adjoins the central mass element. The use of this characteristic feature results in a reduction of the closed chamber, which leads to greater pressure variations when the radiator body moves. An advantage of this that very thin connecting limbs can be used, preferably membranous limbs. Preferably, the projection is annular.

An embodiment of the radiator in accordance with the invention has the characteristic feature as defined in claim 5. This embodiment may further have the characteristic feature as defined in claim 6.

An embodiment of the radiator in accordance with the invention is characterized in that the sealed chamber contains a damping means for damping movements of the gaseous medium. The use of this characteristic feature enables the mechanical Q factor of the mass-spring systems to be reduced, as a result of which any mutual resonances are damped out very effectively.

In the embodiment described above the damping means preferably comprises an annular body of a porous material, for example a cellular material such as a polyurethane foam. Such a material has a structure of small open cells. In operation, i.e. while the radiator body performs a translation, a gaseous medium present in the closed chamber flows through said cellular structure. This flow presents a mechanical resistance to translational movements of the radiator body with respect to its environment.

A practical embodiment of the radiator in accordance with the invention is characterized in that the annular body of a porous material forms part of the central mass element of the radiator body. The annular body may then be a part secured to the central mass element. The central mass element may be provided with a tuning mass, for which purpose a recess or cavity may be provided.

An embodiment of the radiator in accordance with the invention is characterized in that the number of mass elements is two, three or four. Although it is possible to use more mass elements, it has been found that a construction using two, three or four mass elements is satisfactory and can well be realized in practice in order to obtain a reliable radiator which is free from undesired noises and has a large excursion.

An embodiment of the radiator in accordance with the invention is characterized in that the shapes of the connecting limbs are identical to one another. This embodiment is to be preferred if it is an object to give each mass element the same maximum axial excursion with respect to its adjacent mass element or adjacent mass elements. In a practical embodiment, the connecting limbs may be, for example, omega-shaped. Any further connecting limbs are preferably arranged mirror-inverted positions with respect to each other for reasons of symmetry, so as to prevent asymmetry in the excursions and amplitudes of the mass elements.

An embodiment of the radiator according to the invention is characterized in that at least a number of the connecting limbs are of mutually different sizes, said sizes increasing in a direction away from the central mass element. By this measure it is achieved that in relative terms, i.e. relative to its adjacent centrally disposed or more centrally disposed mass element, an annular mass element can perform a greater maximum relative displacement. An advantage of this configuration is that the connection units are utilized in an optimum manner without the deflections causing any undesired deformations of the connecting limbs.

The invention further relates to a loudspeaker system comprising an enclosure or cabinet which accommodates an electrodynamic loudspeaker and a passive radiator. The loudspeaker may be of any type which is known per se. The passive radiator present in the loudspeaker system according to the invention is constructed as defined in any one of the claims 1 through 7. The connection units of the passive radiator in the system according to the invention allow well-defined mutual displacements of the mass elements under the influence of pressure variations in the enclosure, which displacements result in comparatively large air displacements, thereby enabling a comparatively high sound pressure to be achieved. Under the influence of pressure variations in the enclosure the various connection units in such a system allow excursions which are fully adapted to the total moving mass of the radiator and the tuning frequency, the so-called Helmholtz resonance, of the system. For the above-mentioned reason the resonant frequency of the mass spring systems that have been provided is preferably equal to the Helmholtz frequency of the enclosure including the loudspeaker and passive radiator in the case that the system in accordance with the invention has 2 mass elements.

The invention further relates to an apparatus for presenting audible and, at option, visible information, the apparatus in accordance with the invention including the loudspeaker system in accordance with the invention. Such an apparatus is, for example, an audio-video or multi-media apparatus.

With regard to the claims it is to be noted that various combinations of characteristic features as defined in the claims are possible.

The invention will now be described in more detail by way of example with reference to the drawings, in which

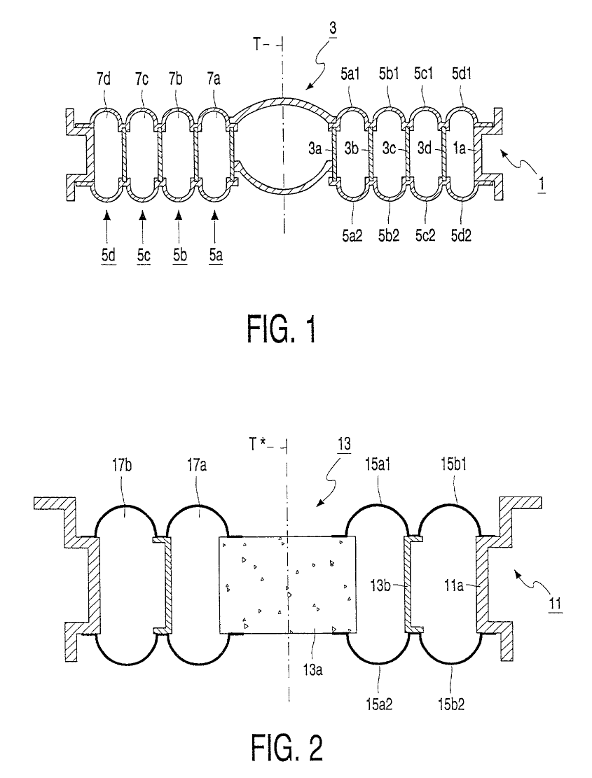

FIG. 1 is a diagrammatic longitudinal sectional view which shows a first embodiment of the passive radiator in accordance with the invention,

FIG. 2 is a diagrammatic longitudinal sectional view which shows a second embodiment of the passive radiator in accordance with the invention in a rest condition,

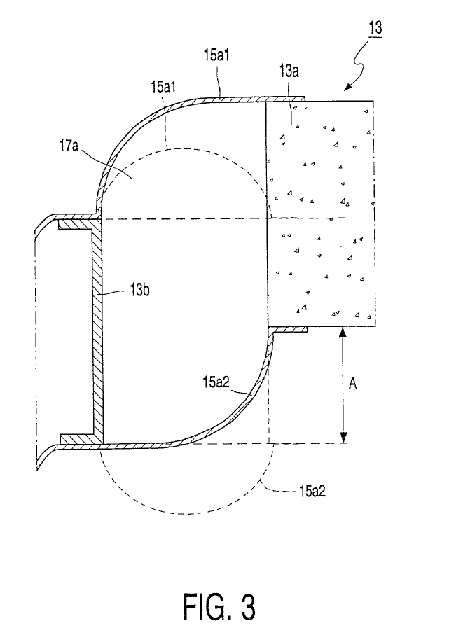

FIG. 3 is a diagrammatic longitudinal sectional view which shows a second embodiment of the passive radiator in accordance with the invention in an operating condition,

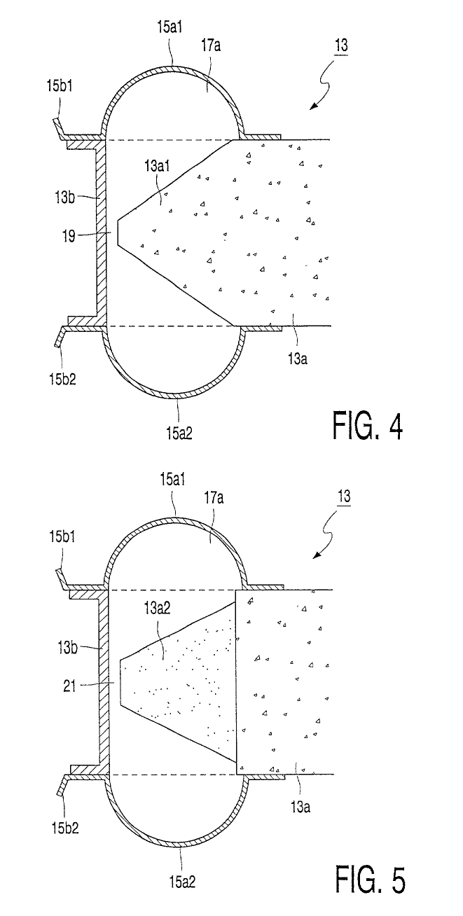

FIG. 4 is a diagrammatic longitudinal sectional view which shows a third embodiment of the passive radiator in accordance with the invention,

FIG. 5 is a diagrammatic longitudinal sectional view which shows a fourth embodiment of the passive radiator in accordance with the invention,

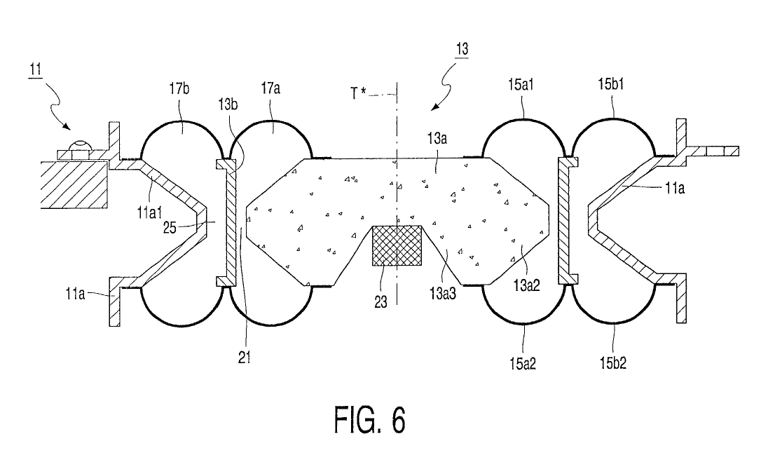

FIG. 6 is a diagrammatic longitudinal sectional view which shows a fifth embodiment of the passive radiator in accordance with the invention,

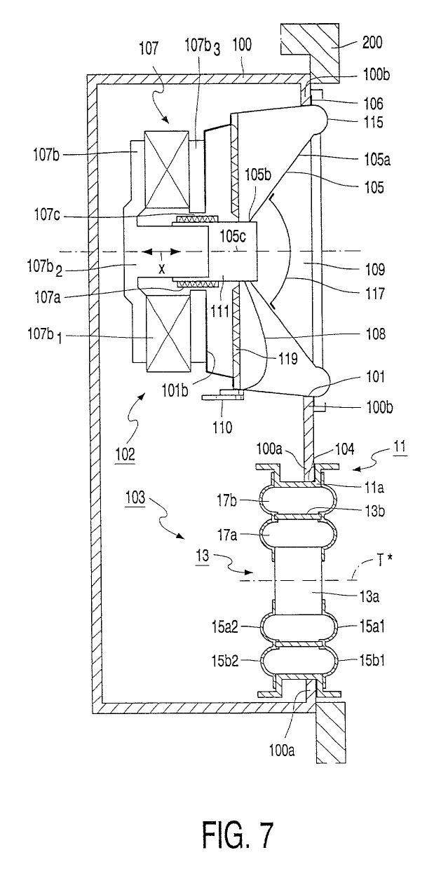

FIG. 7 is a diagrammatic longitudinal sectional view which shows an embodiment of the loudspeaker system in accordance with the invention, and

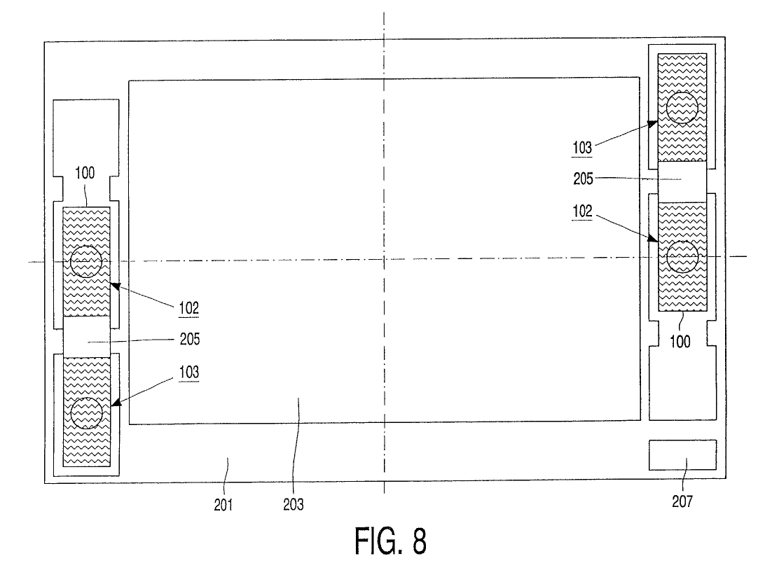

FIG. 8 is a diagrammatic front view which shows an embodiment of the apparatus in accordance with the invention.

The passive radiator in accordance with the invention shown in FIG. 1 is suitable for use in a bass reflex loudspeaker system. The radiator comprises a chassis 1, a radiator body 3 which is movable relative to the chassis 1 along a translation axis T, and connection means for flexibly connecting the radiator body 3 to an element 1a of the chassis 1. In the present example the element 1 a is cylindrical. The radiator body 3 in the present example comprises a central mass element 3a and three mass elements 3b, 3c and 3d which are arranged concentrically with respect to the mass element 3a. The central mass element 3a in the present example is constructed as a cylinder having an imperforate cylindrical wall closed with two convex end faces. The other mass elements 3b, 3c and 3d in the present example are also cylinders but have open end faces. The cylinders may be have imperforate cylindrical walls or more or less open cylindrical walls. In the present example said connection means comprise four connection units 5a 5b, 5c and 5d. The three connection units 5a, 5b and 5c serve for connecting the two respective adjacent mass elements 3a and 3b; 3b and 3c; and 3c and 3d so as to be movable relative to one another. The connection unit 5d serves for movably connecting the mass element 3d to the element 1 a of the chassis 1. In the present example, each of the connection units 5a, 5b, 5c and 5d is formed by two annular connecting limbs 5a1, 5a2; 5b1, 5b2; 5c1, 5c2; and 5d1, 5d2, respectively. In the present example, these connecting limbs are of omega-shaped cross-section and are made of rubber. At their edges the annular connecting limbs are connected to the mass elements 3a, 3b, 3c and 3d and to the element 1a of the chassis 1, as applicable, by fixing means which are known per se, such as an adhesive, and, on account of their shapes and material properties, have a behavior such that during use mainly movements of the mass elements 3a, 3b, 3c and 3d along the translation axis T are admitted, while undesirable tilting movements of the mass elements are counteracted. In the present example, the connecting limbs are identical to one another, wave crests of two facing connecting limbs 5a1 and 5a2; 5b1 and 5b2; 5c1 and 5c2; and 5d1 and 5d2 being remote from each other so as to obtain a symmetrical suspension arrangement.

The passive radiator in accordance with the invention, as shown in FIG. 1, has four mass spring systems which are independent of one another. These mass spring systems are formed by the mass element 3a with its adjacent connection unit 5a formed by the adjacent connecting limbs 5a1 and 5a2; the mass element 3b with its adjacent connecting limbs 5a1, 5a2 and 5b1, 5b2; the mass element 3c with its adjacent connecting limbs 5b1, 5b2 and 5c1, 5c2; and the mass element 3d with its adjacent connecting limbs 5c1, 5c2 and 5d1, 5d2. One of the characteristic features of the embodiment shown is that the mass spring systems all have the same or substantially the same resonant frequency so as to ensure that the mass elements 3a, 3b, 3c and 3d always move in phase during operation. The embodiment of the passive radiator in accordance with the invention as shown in FIG. 1 has four concentric continuous chambers 7a, 7b, 7c and 7d which are coaxial with the translation axis T and which are, respectively, bounded by the central mass element 3a, the connecting limbs 5a1, 4a2 and the mass element 3b; the mass element 3b, the connecting limbs 5b1, 5b2 and the mass element 3c; the mass element 3c, the connecting limbs 5c1, 5c2 and the mass element 3d; the mass element 3d, the connecting limbs 5d, 5d2 and the element 1a of the chassis 1. Of the chambers 7a, 7b, 7c and 7d the chamber 7a is closed or sealed and filled with air of which the pressure in the position shown, i.e. the rest position, of the radiator corresponds to the atmospheric pressure. The pressure may alternatively be slightly higher than the atmospheric pressure. The measures that have been taken ensure a reliable operation of the passive radiator, the maximum displacement of the central mass element 3a from its rest position being the sum of the maximum excursions allowed by the individual connection units 5a, 5b, 5c and 5d. It will be obvious that the maximum displacement of the mass element 3b is the sum of the maximum excursions of the individual connection units 5b, 5c and 5d; the maximum displacement of the mass element 3c is the sum of the maximum excursions of the connection units 5c, and 5d; and the maximum displacement of the mass element 3d corresponds to the maximum excursion of the connection unit 5d. Large air displacements are possible as a result of the comparatively large maximum displacement of the radiator body 3 obtained here.

The easy-to-realize and, consequently, practical passive radiator according to the invention shown in FIG. 2 has a chassis 11 and a radiator body 13 which comprises two mass elements. The radiator body 13 is movable relative to the chassis 11 along a translation axis T*. The radiator body 13 has a cylindrical central mass element 13a which is circumferentially closed and a cylindrical mass element 13b which is circumferentially closed. The chassis 11 has a cylindrical element 11a. The elements 11a, 13a and 13b all lie in one zone and are arranged coaxially with one another, the central axis of the central mass element 13a being coincident with the translation axis T*. The mass elements 13a and 13b are mechanically interconnected by means of a pair of resilient annular connecting limbs 15a1 and 15a2. The mass element 13b is also mechanically connected to the element 1 1a of the chassis 11 by means of a pair of resilient annular connecting limbs 15b1, 15b2. The configuration of mass elements 13a and 13b and connecting limbs 15a1, 15a2 and 15b1, 15b2 as used in this embodiment implies that there are two mass spring systems. These mass spring systems are formed by the mass element 13a and the pair of connecting limbs 15a1, 15a2; by the mass element 13b and the connecting limbs 15a1, 15a2 and 15b1, 15b2. These mass spring systems have the same resonant frequency (natural frequency). The connecting limbs used 15a1, 15a2 and 15b1 are made of rubber or another air-tight material and are all flexible and compliant in directions parallel to the translation axis T* and offer sufficient resistance to lateral deformations. In the present embodiment the space bounded by the central mass element 13a, the mass element 13b, both made of for example a hard plastic, and the connecting limbs 15a1 and 15a2 connected to the elements 13a and 13b takes the form of a sealed chamber 17a, in which a volume of air is present. If desired, the space bounded by the mass element 13b, the element 1 1a and the connecting limbs 15b1 and 15b2 connected to these two elements may also take the form of a sealed chamber 17b, in which case the element should be circumferentially closed.

The embodiment shown in FIG. 2 is shown in its rest position. FIG. 3 shows a part of this embodiment but now the radiator body 13 has performed a movement along the translation axis T* out of the rest position under the influence of external pressure variations, the central mass element 13a having an excursion A with respect to mass element 13b. The shape of the connecting limbs 15a1 and 15a2 in the rest position of the radiator is shown in broken lines in FIG. 3. In the operating position of the radiator the volume of the sealed chamber 17a, as is also illustrated in FIG. 3, is smaller than in the rest position. This means that there has been a rise in air pressure during the movement of the mass element 13a with respect to the mass element 13b. As stated hereinbefore, such a rise in pressure has a favorable effect on the behavior of the connecting limbs 15a1 and 15a2, particularly as regards the maintenance of their bent shapes. As a result of the measures taken, the connecting limbs 15a1 and 15a2 can be surprisingly thin. In the present example the thickness is 0.3 mm.

In the following description of further embodiments the same reference numerals as used in the description of the embodiment shown in FIG. 2 will be used for like parts in the various embodiments.

In the embodiment of the radiator in accordance with the invention shown in FIG. 4 the central mass element 13a, which in the present embodiment is made of a hard plastic, has a radially projecting annular projection 13a1 which surrounds the mass element 13a concentrically. The annular projection 13a1, which is integral with the mass element 13a and has inherently imperforate walls, extends into the air-filled sealed chamber 17a. The presence of the projection 13a1 provides a substantial reduction of the volume of the chamber 17a, as a result of which comparatively large pressure variations can occur during axial excursions of the mass element 13a with respect to the mass element 13b. With the mass element 13b in the sealed chamber 17a the projection 13a defines a narrow passage 19, which has a damping effect on the air streams produced in the chamber 17a during movements of the radiator body 13 with respect to the chassis 1. The annular projection 13a1 preferably has trapezoidal longitudinal section which decreases in a radially outward direction.

The embodiment shown in FIG. 5 has a central mass element 13a to which an annular body 13a2 of a porous material, in the present example a polyurethane foam, is secured. The annular body 13a2 is disposed in the sealed chamber 17a and in operation it has a damping effect on air streams generated in the chamber 17a. In a longitudinal sectional view the porous body 13a2 is tooth-shaped and has a top facing the adjacent mass element 13b. Preferably, a narrow annular gap 21 is formed between the body 13a and the mass element 13b.

FIG. 6 shows an embodiment of the passive radiator in accordance with the invention having two sealed chambers 17a and 17b. The central mass element 13a has a central base 13a3 and an annular body 13a2 which extends into the sealed chamber 17a, the base 13a3 and the body 13a2 forming an integral body having imperforate walls. In a central area the mass element 13a has a cavity for receiving a tuning mass 23. In the present example the element 11a of the chassis 11 has an annular inward projection 11 al in order to reduce the volume of the chamber 17b. A passage 25 is situated between the projection 11a1 and the facing mass element 13b.

The loudspeaker system in accordance with the invention shown in FIG. 7, i.e. a bass reflex system, comprises an enclosure or acoustic box 100 which accommodates the passive radiator in accordance with the invention, in the present example a radiator in accordance with the embodiment shown in FIG. 2 and bearing the reference numeral 103, and an electrodynamic loudspeaker 102. The loudspeaker 102 drives the radiator 103 during operation, the loudspeaker and the radiator in this example together providing the sound production in the low-frequency range of the sound spectrum. The system is consequently a sub-woofer device. The enclosure 100 of the system has a first opening 104 through which the chassis 101 of the passive radiator 103 extends, and a second opening 106 through which a chassis 101 of the loudspeaker 102 extends. The chassis 11 and the chassis 101 are secured to the edge portions 100a and 100b of the enclosure which surround the openings 104 and 106, respectively.

For a more detailed description of the passive radiator 103, reference is made to the passages in the present document which relate to the radiator shown in FIG. 2, and it is to be noted that the resonant frequency of the mass spring systems provided in the radiator 103 is equal to the Helmholtz resonance of the system.

The loudspeaker 102 used in the system shown comprises a conical diaphragm 105 and an electromagnetic actuator 107. In the present example, a dust cap 117 is present in the diaphragm 105. The diaphragm 105 has a front part 105a with an opening 109 and a rear part 105b with a tubular central element 111. The element 111 carries a first actuator part 107a of the actuator 107, which part takes the form of a coil in the present example. The coil 107a is electrically connected to terminals 110 disposed on the chassis 101 via electrical conductors 108. The actuator 107 further comprises a second actuator part 107b, which in the present example includes an annular magnet 107b1, a yoke part 107b2, and a yoke part 107b3 secured to a chassis part 101b of the chassis 101. An air gap 107c, in which the coil 107a extends, is formed between the yoke parts 107b2 and 107b3. When the actuator is energized, the coil 107a, and thus the diaphragm 105, will perform an axial excursion along a diaphragm axis 105c in either of the axial directions indicated by a double arrow X.

The loudspeaker 102 has been provided with a flexible connecting limb 115, which connects the front part 105a of the diaphragm 105 to the chassis 101. In the present example the flexible connecting limb 115 is constructed as an annular element of omega-shaped cross-section. The connecting limb 115, which is made for example of polyurethane, may be connected to the diaphragm 105 and the chassis 101 by means of an adhesive joint.

In the present example, the loudspeaker 102 further includes a flexible centering element 119 in the form of a centering disc having a concentric corrugation pattern and made of a suitable material, such as a textile fabric, which connects the chassis 101 to the back part 105b, in particular to the central element 111 thereof. The centering element 119 and the connecting limbs 113 and 115 are suspension means which are comparatively slack and flexible in axial directions indicated by the arrow X but which are comparatively stiff in other directions, as a result of which the diaphragm 105 with the coil 107a is capable of performing well-defined axial excursions with respect to the chassis 101. Obviously, another loudspeaker than the loudspeaker shown may be used, such as a loudspeaker element with a multiply suspended vibration system. * The apparatus in accordance with the invention shown in FIG. 8 is a flat-panel multimedia TV set. The apparatus has a cabinet 201 which accommodates a display screen 203 and two loudspeaker systems in accordance with the invention. The cabinet 201 has an on/off-switch unit 207 at its front side. The loudspeaker systems in the present example correspond to the loudspeaker system as shown in FIG. 7 and bear the reference numeral 205 in FIG. 8. Each loudspeaker system 205 consequently has an enclosure 100 with a loudspeaker 102 and a passive radiator 103 in accordance with the invention. Instead of the apparatus shown, the apparatus in accordance with the invention may alternatively be a conventional TV set, a monitor, or a piece of audio equipment. Furthermore, the radiator used in the apparatus may be constructed as shown in FIGS. 1, 3, 4, 5 or 6 or in some other manner within the scope of the invention, and a loudspeaker different from the loudspeaker shown in FIG. 7 may be used. Furthermore, the invention is not limited to the embodiments of the passive radiator shown in the Figures. For example, instead of two, three or four mass elements, more than four mass elements may be used, and instead of omega-shaped connecting limbs sinusoidal or differently shaped suitable connecting limbs may be used.

1. A passive radiator comprising a chassis and a radiator body which is connected to said chassis and which is movable with respect to said chassis along a translation axis, the radiator body comprising a central mass element and at least one mass element which is arranged concentrically with respect to the central mass element, connection units being provided for movably interconnecting every two adjacent mass elements and for movably securing one of the mass elements to the element of the chassis, each of said connection units comprising two resilient annular connecting limbs, to which two connecting limbs two adjacent elements which form part of the said elements are secured, the connecting limbs of at least one of the connection units bounding a closed chamber which extends between the elements secured to said units and which is filled with a gaseous medium, the central mass element with its adjacent connection unit, as well as each concentrically arranged mass element with its adjacent connecting limb, forming a mass spring system, all the mass spring systems thus defined having at least substantially the same resonant frequency.

2. A passive radiator as claimed in claim 1, in which the connection units allow mainly movements of the mass elements along the translation axis of the radiator body and counteract other movements.

3. A passive radiator as claimed in claim 1, in which a sealed chamber extends at least between the connecting limbs of the connection unit which adjoins the central mass element.

4. A passive radiator as claimed in claim 3, in which the central mass element has a projection which extends to a location between the connecting limbs of the connection unit which adjoins the central mass element.

5. A passive radiator as claimed in claim 1, in which a sealed chamber extends at least between the connecting limbs of the connection unit which adjoins the element of the chassis.

6. A passive radiator as claimed in claim 5, in which the element of the chassis has a projection which extends to a location between the connecting limbs of the connection unit which adjoins the element of the chassis.

7. A passive radiator as claimed in claim 1, in which the sealed chamber contains a damping means for damping movements of the gaseous medium.

8. A passive radiator as claimed in claim 7, in which the damping means comprises an annular body of a porous material.

9. A passive radiator as claimed in claim 8, in which the annular body of a porous material forms part of the central mass element.

10. A passive radiator as claimed in claim 1, characterized in that the number of mass elements is two, three or four.

11. A passive radiator as claimed in claim 1, characterized in that the shapes of the connecting limbs are identical to one another.

12. A passive radiator as claimed in claim 1, characterized in that at least a number of the connecting limbs are of mutually different sizes, said sizes increasing in a direction away from the central mass element.

13. A loudspeaker system comprising an enclosure which accommodates an electrodynamic loudspeaker and a passive radiator as claimed in any one of the claims 1 through 12.

14. A loudspeaker system as claimed in claim 13, in which the number of mass elements is two and in which the resonant frequency of the mass spring systems defined in claim 1 is equal to the Helmholtz frequency of the enclosure including the loudspeaker and the passive radiator accommodated therein.

15. An apparatus for presenting audible and, at option, visible information, the apparatus including the loudspeaker system as claimed in claim 13 or 14.
